(19) United States
(12) Patent Application Publication
(10) Pub. No.: US 2026/0289204 A1
(43) Pub. Date: Sep. 24, 2026

(54) MICROTRANSPONDER BASED BATTERY TAGGANTS

(71) Applicant: P-CHIP IP HOLDINGS INC., Chicago, IL (US)

(72) Inventors: Aditya L GOTTUMUKKALA, Belmont, MA (US); William E EIBON, Elyria, OH (US)

(73) Assignee: P-CHIP IP HOLDINGS INC., Chicago, IL (US)

(21) Appl. No.: 19/475,617

(22) PCT Filed: Apr. 17, 2024
(86) PCT No.: PCT/US2024/024968

§ 371 Date: Oct. 15, 2025

Related U.S. Application Data
(60) Provisional application No. 63/496,795, filed on Apr. 18, 2023.

(51) Int. Cl. G06K 7/10; G06K 19/07; H01M 10/48

(52) U.S. Cl. CPC G06K 7/10366; G06K 19/0723; H01M 10/488

(57) ABSTRACT

One or more microtransponders may be attached to at least a component of or location in a battery cell and may be configured to provide digital information to a reader, thereby enabling the reader to authenticate the battery cell.

### CROSS REFERENCE TO RELATED APPLICATIONS

This application claims priority to U.S. Provisional Application No. 63/496,795, entitled “Microtransponder Based Battery Taggants,” filed Apr. 18, 2023, which is incorporated by reference herein in its entirety.

### TECHNICAL FIELD

The present disclosure relates to trackable secure taggants that are part of a battery or component thereof. Disclosed are methods of inclusion of secure taggants to various battery components and practical applications thereof.

### BACKGROUND OF THE DISCLOSURE

Batteries have become integral to modern life, enabling communication, work, travel, health, and well-being. They have become critical components of life-saving medical equipment such as Automated External Defibrillators (AEDs), oximeters, etc., where their proper, repeated, and reliable function is central to the functioning of the equipment. As another example, usage of batteries will increase significantly in electrical vehicles—a safety-critical use case—over the years.

In many instances, batteries are situated in close proximity to users, such as next to the ear of a user using a cell phone, on the lap of a user using a laptop computer, or underneath the seat of a user in an electric vehicle. Therefore, the safe and reliable operation of batteries is crucial for the life of the device in which they are used and critical for the safety of the human users of these devices.

In a variety of situations, such as when repurposing or recycling batteries, it may be desirable to track battery systems, battery packs, batteries, cells, and/or components throughout their lifecycle. This can be facilitated through tagging batteries or portions thereof. Existing solutions for tagging of batteries rely on using RFID technology to identify the battery and, in certain cases, the enclosure containing the battery. In United States Patent Application No. US20070008141A1, Sweeland describes tagging of individual cells and the battery pack (the enclosure) with an RFID tag. Yao describes the use of a plurality of identifiers, such as NFC tags and RFID tags, for purposes of identification of both individual cells and battery packs in U.S. Patent Application No US20110121951A1. Yao highlights the value of covertly installing a tag under the protective outer layer as an additional security measure to identify counterfeit cells and battery packs.

RFID and NFC tags suffer from technical drawbacks that significantly limit their utility for tagging batteries. For example, read distances of RFIDs are adversely affected due to thermal events, a common occurrence during the charging and discharging of batteries and cells. Further repeated exposure to heating and cooling tends to reduce the usable life of RFID and NFC tags due to the weakening of the solder joints.

Another major limitation of RFID and NFC tags is their inability to be applied for tagging components inside a battery cell. First, the relatively large size of these tags (typically 2-5 cm along each side) makes them impractical for tagging components such as separators, electrodes, and current collectors of commonly used cells (such as 18650 Li-ion cells, AA batteries, etc.), as the tag would occupy a significant portion of the electrode. Major structural and functional changes would have to be made to the battery cell design to accommodate these large size tags. Second, the read characteristics of the RFID or NFC tag are adversely impacted when placed inside an electrically charged environment such as a cell. For example, the electric field within the cell generally distorts the communication between the RFID or NFC tag and the corresponding reader. Third, the harsh chemical environment inside the cell tends to corrode away the metallic components of an NFC or RFID (such as the antenna) rendering them unusable or drastically reducing their usable lifetime. Fourth, when multiple RFID or NFC tags are placed within close proximity to one another (such as cells in a battery), there is the likelihood of “tag collision” when attempting to read an RFID or NFC. That is, it can be hard for a reader to ascertain which RFID or NFC is being read.

### SUMMARY OF THE DISCLOSURE

In some embodiments, this disclosure relates to a taggant for a battery cell. The taggant may comprise a microtransponder attached to at least a component of a battery cell and configured to provide digital information to a reader, thereby enabling the reader to authenticate the battery cell. In some embodiments, the component may comprise at least one of a separator, a current collector, an electrode, a safety valve, a gasket, a current interrupt device, a positive temperature coefficient (PTC) thermistor, and an electrolyte.

In some embodiments, this disclosure relates to a taggant for a battery cell. The taggant may comprise a microtransponder attached to a location in the battery cell and configured to provide digital information to a reader, thereby enabling the reader to authenticate the battery cell. In some embodiments, the location may comprise at least one of a cap, a crimp, a gasket, and a covering. In some embodiments, the location may be beneath a visible surface of the battery cell. In some embodiments, the microtransponder may be attached to the battery cell by heat staking the microtransponder into a polymeric covering of the battery cell. In some embodiments, the microtransponder may be attached to the battery cell by placing the taggant into interstices of a crimp. In some embodiments, the microtransponder may be attached to the battery cell by using an adhesive and/or a label. In some embodiments, the adhesive may be a one-component adhesive such as at least one of a silicone-based composition, a polyurethane-based composition, cyanoacrylate-based composition, and a methacrylate-based composition. In some embodiments, the adhesive may be a two-component adhesive such as at least one of an epoxy-based composition, a polyurea-based composition, polyurethane-based composition, and a reactive acrylate-based composition. In some embodiments, the adhesive may be an ultraviolet (UV), thermal, or oxidative cured adhesive and/or a pressure sensitive adhesive. In some embodiments, the microtransponder may be in or on a label using any of the above adhesives to affix the lael to a target, and/or any other technique for attaching the label to the target.

In some embodiments, this disclosure relates to a battery taggant system in a battery environment. The battery taggant system may include at least one first microtransponder forming a first level of hierarchy in the battery taggant system and at least one second microtransponder forming a second level of hierarchy in the battery taggant system. Each of the first microtransponder and the second microtransponder may be configured to provide digital information to a reader, thereby enabling the reader to individually or hierarchically authenticate a corresponding portion of the battery environment. In some embodiments, the battery environment may comprise a single battery cell, the first microtransponder may be attached to the battery cell, and the second microtransponder may be attached to a cell component within the battery cell. In some embodiments, the battery environment may comprise a battery, the first microtransponder may be attached to the battery, and the second microtransponder may be attached to a battery cell within the battery. In some embodiments, the battery environment may comprise a battery pack, the first microtransponder may be attached to the battery pack, and the second microtransponder may be attached to a battery within the battery pack. In some embodiments, the battery environment may comprise a battery system, the first microtransponder may be attached to the battery system, and the second microtransponder may be attached to a battery pack within the battery system. In some embodiments, the individual authentication may comprise a corresponding microtransponder authenticating the corresponding portion without combining with other microtransponders. In some embodiments, the hierarchical authentication may comprise a corresponding microtransponder authenticating the corresponding portion in combination with at least another microtransponder at a different level of hierarchy. In some embodiments, the hierarchical authentication may comprise a corresponding microtransponder authenticating the corresponding portion in combination with at least another microtransponder at a same level of hierarchy.

In some embodiments, this disclosure relates to battery taggants that are associated with ancillary parts of the battery system, such as elements that are used to connect the battery system. Examples of such ancillary parts may include, but are not limited to, cables, attachments, clips, and connectors.

It is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 depicts a block diagram of an example MTP sensor system in accordance with example embodiments of the present disclosure.

FIG. 2 illustrates a schematic diagram of an example MTP in accordance with example embodiments of the present disclosure.

FIG. 3 illustrates a side view representation of an illustrative MTP in accordance with example embodiments of the present disclosure.

FIG. 4 illustrates a top plan view representation of an illustrative MTP in accordance with example embodiments of the present disclosure.

FIG. 5 depicts a functional block diagram of an illustrative MTP in accordance with example embodiments of the present disclosure.

FIG. 6 is a schematic diagram of a clock recovery circuit in accordance with example embodiments of the present disclosure.

FIG. 7 illustrates a cross-section view of an example photoconductor in accordance with example embodiments of the present disclosure.

FIG. 8 illustrates a timing diagram of the light intensity and the voltage signal at each node of the clock recovery circuit with a coupling capacitor of FIG. 6, in accordance with example embodiments of the present disclosure.

FIG. 9 illustrates a functional block diagram of a MTP reader in accordance with example embodiments of the present disclosure.

FIG. 10A illustrates in simplified form how a string of “1101” is transmitted under an old system, and FIG. 10B illustrates in simplified form how a string of “1101” is transmitted under a reverse antenna system described herein, respectively.

FIG. 11A shows one example diagram of reversing the direction of antenna operation in in accordance with example embodiments of the present disclosure.

FIG. 11B shows another example diagram of reversing the direction of antenna operation in accordance with example embodiments of the present disclosure.

FIG. 12 shows an example battery cell in accordance with example embodiments of the present disclosure.

FIG. 13 shows an example battery hierarchy in accordance with example embodiments of the present disclosure.

FIG. 14 shows example components of a battery cell in accordance with example embodiments of the present disclosure.

FIG. 15 shows a flow diagram of an example method of tagging a battery cell according to example embodiments of this disclosure.

### DESCRIPTION OF THE EMBODIMENTS

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing example embodiments, it is understood that the present disclosure has been made only by way of example, and that numerous changes in the details of implementation of the disclosed subject matter may be made without departing from the spirit and scope of the disclosed subject matter.

As used herein, a battery is a collection of cells (or battery cells). A cell is defined herein as an electrochemical unit that is capable of producing electricity. Constituents that make up a cell are called “cell components” or “components.” A collection of batteries may form a “battery pack.” Multiple battery packs may be connected to form a battery system. In some embodiments, a battery system may be considered the highest level of hierarchy for delivering electricity for a relatively large-scale application such as an electric vehicle or residential electric system, though lower levels in the battery hierarchy (such a single cell or battery or battery pack) may suffice for other applications. Battery management systems may be employed to monitor battery packs and battery systems. It should further be understood that the term “battery” is used as a generic term throughout this disclosure, and any embodiment described in terms of battery is equally applicable to a cell component, a cell, a battery pack, a battery system, and any combination thereof.

Repurposing and recycling of batteries, cells, and cell components is expected to play a key role in the sustainable use of batteries. Repurposed batteries or cells (“second life batteries”) are batteries formed by compiling cells or cell components from different previously used cells. For an effective second life battery, the various individual cells would gain from having similar prior use characteristics, for example, by avoiding any load or charge imbalances in the batteries. That is, carrying over the known characteristics of the used cells to a recycled and/or repurposed battery—to be reused—may generate a dependable recycled and/or repurposed battery with predictable characteristics. When done safely, this recycling offers significant economic benefit. For example, this process may rarely require the individual cells to be dismantled completely and may only involve repackaging of the cells that pass specification testing for the desired purpose. Another example benefit of this recycling and/or repurposing is that it helps to reduce battery waste.

On the other hand, recycling of “end-of-life” batteries involves dismantling a battery or cell to its components, and then recycling the component materials. Typically, the casing, caps and other rigid structural elements of the cells are separated. The chemically active elements such as the electrolyte, electrodes, binder, etc. are typically processed separately, as a mixture commonly referred to as “Black mass” from which elements may be separated.

A technical problem, however, with repurposing or recycling batteries is tracking battery systems, battery packs, batteries, cells, and/or components throughout their lifecycle. Because of the size (i.e., smaller size) and environment (i.e., harsh electrochemical environment) for any type of tracking component (e.g., a taggant), tracking is challenging even for single use batteries or cells. Repurposing and recycling compound the technical problem because the tracking may have to cover different permutations of cells and/or cell components being used for different recycled batteries, battery packs, and battery systems. As described herein, conventional radio frequency identification (RFID) and near filed communication (NFC) have several technical deficiencies and cannot adequately meet the challenges with tracking, particularly in the context of repurposing and recycling of batteries.

Additionally, counterfeit batteries have become an increasing problem to modern commerce. Counterfeiters have resorted to multiple means to resemble genuine batteries. These include, but are not limited to, counterfeit packaging, masking used cells as new, and mixing of sub-standard cells with standard cells in a battery pack. Counterfeiters also have resorted to including counterfeit cell components inside genuine casing. This makes it particularly difficult to identify such counterfeited batteries merely by visual inspection. In certain instances, such counterfeit batteries are combined with other genuine batteries in a grouping of batteries (such as a battery pack) to form second life batteries. This often results in load imbalances, leading to uneven heating or short circuiting of the cells, thereby damaging the device, resulting in a potential injury to the user and the surrounding environment.

To address these and other problems, embodiments described herein may offer technical solutions to efficiently ascertain the authenticity of battery systems, battery packs, batteries, cells and cell components. For example, in some embodiments a single taggant may uniformly authenticate all of the above and provide for a method to associate each of the items in the hierarchy. Some embodiments may associate the authenticated components to a unique identifier of the device where they are included. Some embodiments may provide a hierarchical organization of taggants, so that authentication can be performed at any level of hierarchy. For example, a taggant for a battery can be associated with a group of individual taggants for the constituent cells, which allows for: (1) individual authentication of the constituent cells by using corresponding taggant, (2) group authentication of the cells by using the combination of individual taggants, (3) individual authentication of the battery by using the corresponding taggant, and/or (4) hierarchical authentication by using the hierarchical association between the taggant for the battery and the taggants for the individual cells.

Optically Activated Microtransponders (MTPs) and All Optical Micro-transponders (OMTPs)—a subclass of MTPs, are particularly qualified as security elements. As described herein, MTPs and OMTPs may wirelessly transmit a unique and an incorruptible digital identifier, when scanned with a suitable device (“a reader”). The transmitted signal may be in the form of a radio frequency (RF) signal in case of MTPs, and light in the case of OMTPs. The identifier may be used for the purpose of identifying a tangible object (such as food product), when the transmitted identifier and tangible object are linked, via a database. Their small size, (typically less than 2000 microns along its longest side, preferably less than 600 microns along its longest side), durability, and inertness to a variety of biological and chemical media make MTPs particularly attractive as taggants. The aforementioned sizes are provided as examples and should not be considered limiting. Further MTPs can be easily combined with other security elements (such as QR-codes, holograms, etc.) to form “compound taggants”. Such compound taggants may contain the MTP/OMTP present overtly or covertly. Further, a single reader may be able to read the multiple security elements at once. For the sake of brevity, the description below uses the term MTPs, but the embodiments should equally apply to OMTPs as well. Some embodiments of MTPs are commercially available as p-Chip™ from p-Chip corporation of Chicago, IL.

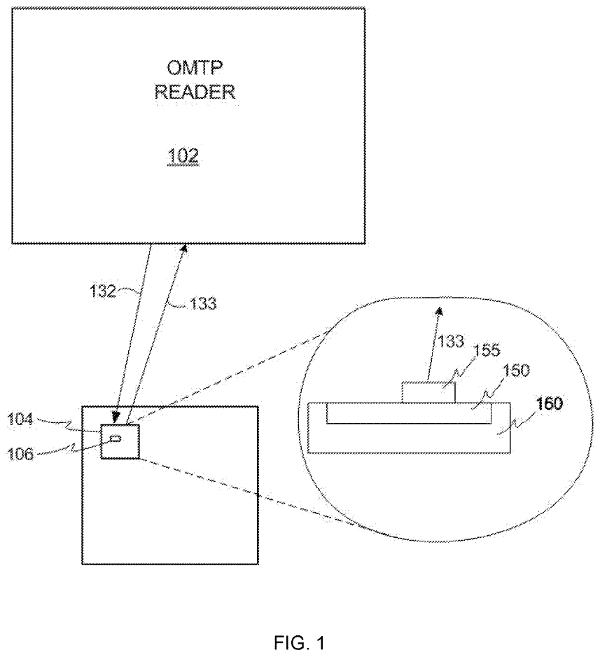

FIG. 1 depicts a block diagram of MTP sensor system 100 (“system 100”) in accordance with some embodiments of the present disclosure. The system 100 comprises a MTP reader 102 and an MTP 104. In some embodiments, the MTP 104 is associated with a battery, or portion thereof, so as to operate as an identifier for the battery or portion thereof. The MTP 104 may be adhered to, implanted within, or otherwise attached to the battery, location therein, or component thereof requiring individual unique identification (ID) data. An enlargement of the MTP 104 is depicted in the breakout shown in FIG. 1 to illustrate MTP components comprising a substrate 160, photo elements 150, and an optical communication circuit 155. The height of the MTP 104 can be, for example, approximately 20 um-60 um and dependent on the number of stacked layers and sensors for a particular MTP 104. The MTP 104 may be an integrated circuit which may be normally in a persistent dormant unpowered state until powered on when illuminated with an excitation beam 132 from the MTP reader 102. Upon illumination, the MTP 104 may power on (generally instantly, e.g., much less than 1 second) and transmit a data beam 133 via light to the MTP reader 102. The data beam 133 in some embodiments may be an emission (e.g., from a light emitting diode (LED)) or, in other embodiments, a reflection/absorption mechanism (e.g., shuttering via liquid crystal display (LCD)). In alternative embodiments, the MTP 104 receives a separate stimulus such as a code modulated onto the excitation beam 132 which initiates transmission of data from the MTP 104. Alternatively, receiving data from an internal or linked sensor may trigger a transmission of the data beam 133.

In some embodiments, the excitation beam 132 is a visible focused light or laser beam, and the data beam 133 is an infrared light beam emission (e.g., from an infrared emitting diode). The data beam 133 may contain a signal to identify the specific MTP 104 to the MTP reader 102, for example using an identification number unique to the specific MTP 104. Using the unique identification information, the MTP reader 102 may transmit data to a computer (not shown) to uniquely identify the battery. In some embodiments, a user may operate the MTP reader 102 to illuminate the MTP 104 with a light or other electromagnetic signal that causes the MTP 104 to transmit the data beam 133 via light or other electromagnetic signal. For example, in some embodiments the range of electromagnetic spectrum used by MTP 104 for this signaling may include one or more subsets of the sub-terahertz portion of the spectrum, including infrared and longer wavelengths. The data beam 133 may be received by the MTP reader 102. The MTP reader 102 then may decode the data beam 133 carrying identification data to unambiguously identify the object.

“Laser” shall be defined herein as coherent directional light which can be visible light. A light source includes light from a light emitting diode (LED), solid state lasers, semiconductor lasers, and/or the like, for communications. The excitation beam 132 in some embodiments may comprise visible laser light (e.g., 660 nm wavelength). In some embodiments, the excitation beam 132 in operation may illuminate a larger area than that occupied by the MTP 104, thereby allowing a user to localize and read the MTP 104. In some embodiments, the excitation beam 132 may comprise other wavelengths of light in the visible and/or invisible spectrum to supply sufficient power generation using photo elements 150 of the MTP 104. The data beam 133 may be emitted with a different wavelength than the excitation beam 132. For example, the data beam 133 may be 1300 nm IR light while the excitation beam is 660 nm red light. However, other wavelengths, such as the near-infrared (NIR) band, may be used for optical communication and alternative embodiments may use other communication techniques such as reflective signaling methods to return a modulated data signal to the MTP reader 102. In some alternative embodiments, the MTP 104 comprises an antenna (e.g., an integrated antenna) for communicating ID information to the MTP reader 102 via radio waves rather than a light-based signal.

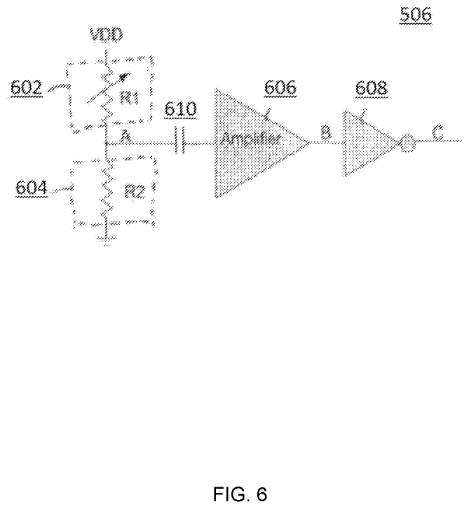

In some embodiments, the MTP 104 may comprise a clock recovery circuit 106. The clock recovery circuit 106 may extract a clock pulse signal from the received modulated light beam as described in detail further below with respect to FIGS. 6-8. In one embodiment, the light of the excitation beam 132 is amplitude modulated (e.g., pulsed) at approximately 1 MHZ to provide the data clock which may be used by the MTP 104 for supplying the operation clock pulses, for example, of transmitted ID data bits. The timing of the pulse groups can be set so that the duty cycles and average power levels fall within requirements for registration as a Class 3R laser device.

An example MTP can be a monolithic (single element) integrated circuit (e.g., 600 μm×600 μm×100 μm) that can transmit its identification code through radio frequency (RF). This dimension is just an example and should not be considered limiting. For example, the monolithic integrated circuit may have maximum dimensions of 2 mm length, 2 mm width, and 0.2 mm thickness.

When there are a plurality of MTPs, each MTP (e.g., MTP 104) may have a unique serial number or identifier (ID) programmed or otherwise assigned thereto. MTPs may be read by the MTP reader 102 (e.g., a wand) with no duplicate IDs. The MTP reader 102 may be a hand-held device connected to a standard Windows PC, laptop or tablet used to read the MTP and may be capable of reading the serial number or ID of individual MTPs.

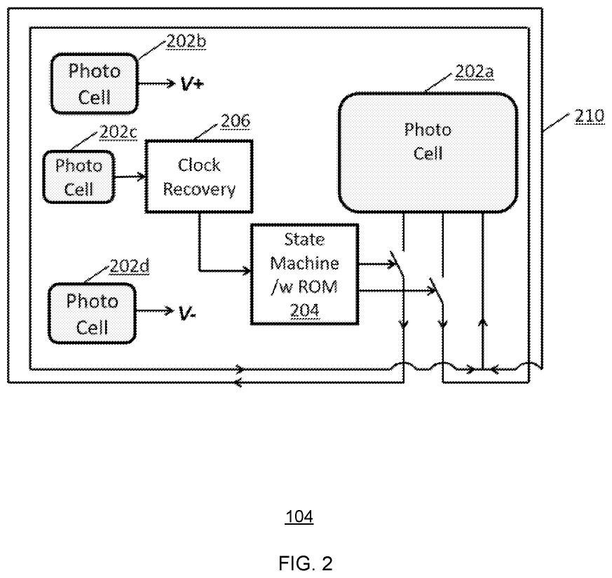

FIG. 2 illustrates a schematic diagram of an example MTP 104 in accordance with some embodiments of the present disclosure. As shown, the MTP 104 may include photocells 202a, 202b, 202c, 202d (commonly referred to as a photocell 202 and collectively referred to as photocells 202); clock recovery circuit 206 (e.g., clock signal extraction circuits); a logical state machine 204; a loop antenna 210; and a 64-bit memory (not shown) supporting, for example, over 1.1 billion ID codes. The photocells 206, when illuminated by a pulsed laser, may provide power to the electronic circuits on the chip with, for example, ~10% efficiency. The MTP 104 may transmit its ID through modulated current in the antenna 210. The varying magnetic field around the MTP 104 may be received by a coil in the reader, and the signal may be digitized, analyzed, and decoded. MTPs (such as the shown MTP 104) may be manufactured on silicon wafers in foundries, using CMOS processes similar to those used in the manufacturing of memory chips and computer processors. Wafers may receive post-manufacturing treatment including laser encoding, passivation, thinning, and dicing to yield individual MTPs. For example, the MTP 104 surface may be made of silicon dioxide, which is deposited as a passivation layer. The silicon dioxide used as a passivation layer is just an example material and should not be considered limiting. The passivation layer encloses the other components and forms a chemical and biological barrier. Therefore, the MTP 104 can safely operate within a battery regardless of the chemical makeup and/or temperature of the environment therein.

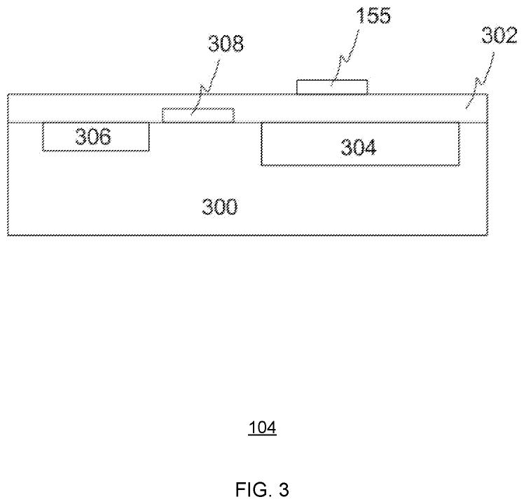

FIG. 3 illustrates a side view representation of an illustrative MTP 104 in accordance with at least one embodiment of the invention. The MTP 104 may comprise a stack of individual integrated circuit layers 300, 302, 304, 306, 308. Within the shown individual layers, the layer 302 may support a passivation layer (i.e., receive the material forming the passivation layer). The layer 304 may comprise logic, clock, sensors, and transmitter circuits. Layers 306, 308 may comprise storage capacitors; and 300 may be the substrate. Those of skill in the art will recognize that functions of the MTP 104 can be organized into layers of other configurations. For example, the stacking may comprise layers of differing thicknesses uniformly overlaid so that they can be manufactured for example in a 3D IC process well-known in the art.

The MTP 104 may be manufactured using mixed-signal manufacturing technology that is typically used to make sensor electronics or analog-to-digital converters which comprise both analog and digital devices together. In an example embodiment, each layer is approximately 12 μm thick and 100 μm×100 μm in dimension. In one embodiment, dimensions of the MTP 104 are 100×100×50 μm. Alternative embodiments may use more or less layers as depending on the application.

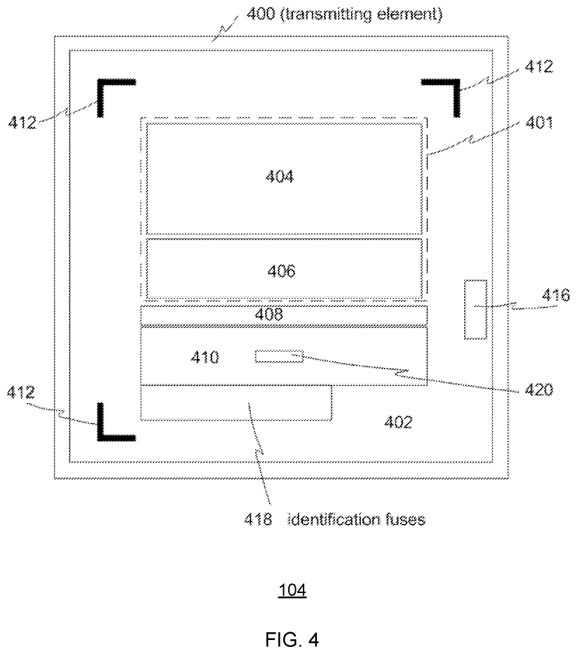

FIG. 4 illustrates a top plan view representation of an illustrative MTP 104 according to some example embodiments of this disclosure. The view depicted in FIG. 4 is of the top layer 302 of FIG. 3. In one embodiment, on top of the layer 302 comprises a transmitting element, such as an LED array 400, that circumscribes the periphery of the MTP 104. In other embodiments, an LED array may be realized as a single LED in the middle of logic/sensor circuits 410 (shown in phantom as LED 420) or other topography for directed light emission. The placement of the LED array 400 depicts an example of an embodiment emphasizing light generation. Alternative embodiments may include varying topography layouts favoring power harvesting or capturing sensor data and the like. In some embodiments, the LEDs may include focusing lenses or other optics.

Centrally located on the example top layer 302 is an array 401 of photocells 402, 404, 406, and photoconductor 408. As illustrated, each photocell in array 401 can be physically sized to create power for a particular circuit within the MTP 104 and one can be dedicated to clock/carrier signal extraction as described below with respect to FIG. 4. Photocell 402, the largest in area, produces a voltage V_{dd} (in some embodiments, a negative voltage, V_{neg}) for operating an output transistor 416 to drive the electronic radiation transmitter (realized in some embodiments as an LED in the optical communication circuit 155). Photocell 404 produces a positive voltage for logic/sensor circuits 410, and photocell 406 produces a negative voltage, V_{neg}, for logic/sensor circuits block 410. Photoconductor 408 is used to extract clock pulses, e.g., for operating the logic/sensor circuits 410. The photocells 401 may be coupled to capacitors, for example, in layers 306 or 308 for storing the energy produced by the photocells when illuminated by laser light. In some embodiments, energy extracted from the clock photoconductor 408 is applied to a differentiator (described below with respect to FIG. 6) which extracts clock edges which are amplified and used to provide timing signals to the logical and sensing circuits. As illustrated, a plurality of identification fuses 418 is located on the surface 414. By opening select ones of these fuses, the MTP 104 is provided a unique identification code range beyond a default base page of code values that may be hard-coded into the chip logic. In an alternative embodiment, the ID values may be electronically coded using electronic antifuse technology. Further still are embodiments with electronic memory for data, signal processing, and identification storage.

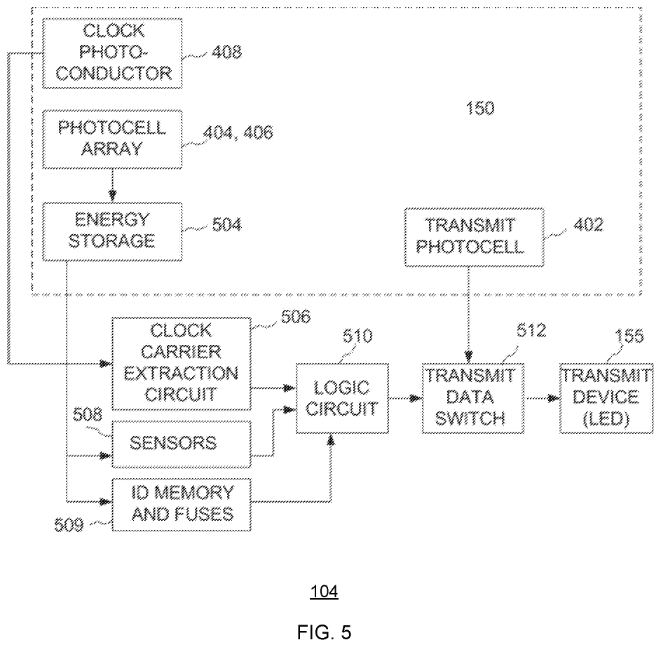

FIG. 5 depicts a functional block diagram of an illustrative MTP 104 in accordance with some embodiments of this disclosure. The MTP 104 may comprise the photo elements 150, energy storage 504, clock/carrier extraction network 506 (i.e., clock recovery circuit 106), sensors 508, logic 510, transmit switching circuit 512, and an infrared (IR) LED 155. The photo elements 150 can include dedicated photocells such as the clock extraction photoconductor 408, the energy harvesting photocell array 404, 406, and the transmit photocell 402. The energy harvesting photocell array 404 and 406 may be coupled to energy storage 504 and may comprise photovoltaic cells which convert light energy from illumination into an electrical current.

The clock photoconductor 408, which is part of the clock recovery circuit and can be physically located in different places from the recovery circuits, may detect a clock pulse signal for the clock/carrier extraction circuit 506. In some embodiments, the energy storage 504 comprises a plurality of capacitors having at least one capacitor coupled to a photocell of the photocell array 404, 406. The energy stored in the energy storage unit 504 may be coupled to the electronic circuits. Since the laser light is pulsed, the energy from the laser may be accumulated and the MTP 104 may operate on the stored energy. Unlike the photocell array 404 and 406, the energy of photocell 402 is not stored and the transmitter switching circuit 512 via output transistor 416 can “dump” all of its energy into the transmit element 155. As the received laser pulse energy is extracted by the clock/carrier extraction circuit 506, the logical state machine (i.e., logic 510) may form data packets comprising the ID bits and sensor data and provide these to the transmit data switch 512 for the formation of the optical transmission signal. The logic 510 may directly integrate the sensor and ID signal(s) into a composite data frame of the OOK (on-off keyed) emitter. The modulation symbols may be applied to the transmitter 512 and transmitted with each pulse of energy.

In some embodiments, the MTP 104 may include sensor(s) 508. The sensor(s) 508 can comprise one or more sensors, for, for example, monitoring properties of the battery or component thereof. Any analog data from the sensor(s) 508 may be converted into a pulse width modulated signal or other binary signaling method that encodes the analog quantity in the time domain in a manner suitable for pulsing the IR emitting diode for direct transmission to the MTP reader 102 without the need for traditional, power and area intensive analog to digital conversion techniques. Example sensors include, but are not limited to, a dielectric sensor, a proportional to absolute temperature (PTAT) sensor, a pH sensor, a redox potential sensor, and/or light sensor. However, other types of sensors are also to be considered within the scope of this disclosure.

FIG. 6 is a schematic diagram of a clock recovery circuit 506 in accordance with some example embodiments of this disclosure. The clock recovery circuit 506 may comprise a photoconductor 602 having a resistance R1 that varies as a function of received light intensity, a reference resistor 604 having a fixed resistance R2, an amplifier 606, and an inverter 608. A source terminal of the photoconductor 602 is coupled to a first terminal of the resistor 604 at a node A. Node A is coupled to the input of the amplifier 606, and the output of the amplifier 606 is coupled to the inverter 608 which generates the recovered clock circuit at its output.

The series combination of the photoconductor 602 and the resistor 604 form a voltage divider R that is coupled between a voltage V_{DD} and ground. Specifically, in this embodiment, a drain terminal of the photoconductor 602 is coupled to the voltage V_{DD} from the energy storage 504, which sustains the voltage when the illumination is off, and the second terminal of the resistor 604 is coupled to ground. Since the resistance R1 of the photoconductor 602 varies as a function of received light intensity, and the voltage at node A is determined by the ratio of the resistances R1 and R2, a modulated light input incident on the photoconductor 602 produces a modulated voltage signal at the input of the amplifier 606.

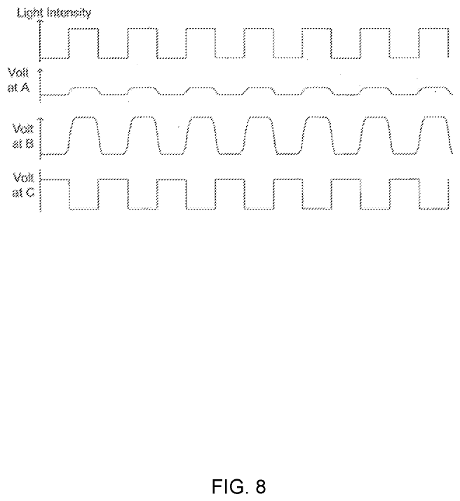

In some embodiments, a coupling capacitor 610 is added in front of the amplifier 606. The voltage divider R and the coupling capacitor 610 form a differentiator which may extract clock edges when the modulating frequency is as low as a few kilohertz (at approximately 1 MHz or above, this may not be necessary). The inverter 608 digitizes the analog output of the amplifier 606, resulting in an example digital waveform as shown in FIG. 8, as described below.

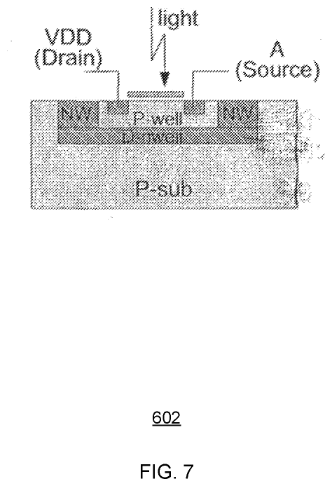

FIG. 7 illustrates a cross-section view of an example photoconductor 602 in accordance with some embodiments of the present invention. In some embodiments, the size of the photoconductor 602 can be 5 μm×5 μm or larger. As illustrated, the photoconductor 602 may employ a long channel n-MOSFET in an isolated deep n-well bucket. The n-wells and the deep n-well (D-nwell) may completely seal the p-well, in the p-substrate, and the transistor components, i.e., the source, drain, and gate which are confined in the bucket. The gate layer, for example made from polysilicon material, may be disposed on top of an insulating layer, such as silicon dioxide (SiO₂). The polysilicon material spectrum-wise absorbs shorter wavelength light, such as blue light, but passes longer wavelength light, such as red light. When using an excitation beam 132 having a longer wavelength, such as a red-light beam, the polysilicon material filters and blocks the shorter wavelengths and passes the long wavelength. As such, it suppresses shorter wavelengths. For example, a room light (e.g., a fluorescent lamp) that flickers at the speed of 60Hz may produce some interference or noise having more spectrum in the shorter wavelength (blue wavelength) range, and the polysilicon material effectively blocks the flickering from the room light and only passes the desired energy beam (e.g., the red light).

Further, the photoconductor 602 (which may also be referred to as a photoresistor) allows the clock recovery circuit 106 to function under both low illumination and high illumination conditions in contrast to photodiode-based clock recovery circuits. For example, under sufficiently high illumination, excessive flooding charges in a photodiode cannot be sufficiently discharged, resulting in the malfunction of a photodiode-based clock recovery circuit. In contrast, the photoconductor 602 can be operated in current mode and may be less affected by the high illumination flooding phenomenon since photo charges are drained constantly by the electric field in the photoconductor 602. Additionally, the deep n-well bucket of the photoconductor 602 is isolated such that the n-wells physically form a potential barrier that prevents charges generated outside of this bucket from entering the bucket, ensuring that only those photons arriving inside the bucket can contribute to the conductivity of the photoresistor 602. As such, excessive photogenerated charges during high illumination, which may result in malfunctioning of photodiode-based clock recovery circuits, is suppressed in the clock recovery circuit 106.

Additionally, this FET device may have a very small physical footprint. For example, the inverter 608 as shown in FIG. 6 can comprise a static CMOS inverter device comprising an NMOS and a PMOS transistor and having two states, either high or low. If the inverter input is above a reference voltage, it is considered to be high, below the reference voltage is considered to be low, and then the output is inverted. The static CMOS inverter can also act as an analog amplifier as it has a sufficiently high gain in its narrow transition region to amplify the signal, enabling the clock recovery circuit 506 to have a very small footprint. In instances where the extracted clock pulse is extremely low, amplification by the amplifier 606 may not be sufficient to reach the threshold voltage for flipping the logic state; in these instances, the inverter 608 can further boost the overall amplification to reach its threshold.

FIG. 8 illustrates a timing diagram of the light intensity and the voltage signal at each node of the clock recovery circuit 506 with a coupling capacitor of FIG. 6.

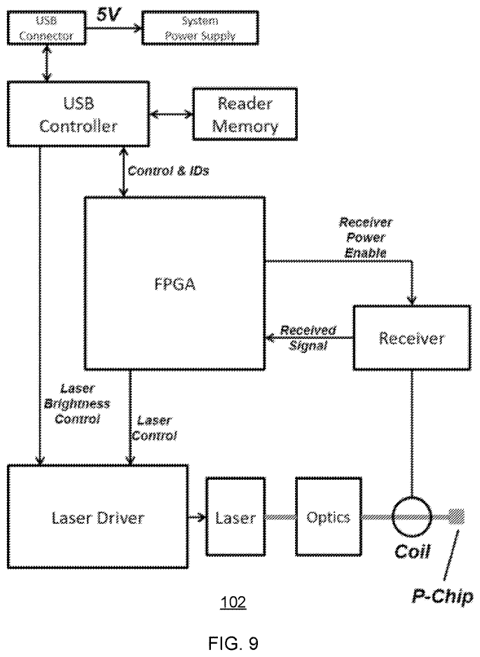

FIG. 9 illustrates a functional block diagram of a MTP reader 102 in accordance with some embodiments of the present disclosure. As illustrated in FIG. 9, an example MTP reader 102 may be USB-powered and may include a USB 2.0 transceiver microcontroller, a field programmable gate array (FPGA), power converters and regulators, a laser diode with the programmable current driver, an optical collimation/focusing module, and a tuned air coil pickup with a high-gain, low-noise differential RF receiver. The example laser emits an average of 60 mW of optical power modulated at 1 MHz at 658 nm wavelength when reading a MTP ID. The ID is read when the MTP is placed within suitable proximity (e.g., <10 mm) from the MTP reader 102. The MTP generated waveform is compared to the data clock (Laser Modulation) used for the synchronization of the transmitted ID data bits. The resulting ID readout from the MTP is rapid (<0.01 s) and is reported on the PC or tablet. The MTP reader 102 may be able to read MTP under challenging conditions, such as through a sheet of white paper, blue-colored glass (~1 mm thick), or a sheet of transparent plastic laminate. Other MTP readers have been developed (e.g., an instrument for reading IDs with the MTP in a fluid). Another version in development is a battery-operated Bluetooth reader that can be used with a PC or cell phone.

Some embodiments may provide efficient systems and methods capable of increasing the signal strength emitted by these small MTPs. The MTP data may be transmitted using a data coding that results in one third to two thirds of the transmitted bits having a value of one. The average for all IDs may be half of the data having a value of one. A “1” digital signal is transmitted with the laser on and a “0” digital signal is transmitted with the laser off (The photocell stored energy provides a small amount of energy to be transmitted). The signal power tracks the ratio of ones to zeros in the data. Some embodiments may transmit a “1” digital signal the same as it currently is transmitted, but a “0” digital signal is transmitted with the laser ON with the current flowing in the opposite direction of the current for a “1” digital signal. This results in all IDs being transmitted with the same power. Data may be transmitted when the laser is on. This may result in twice the power in the transmitted signal (6 dB more signal in the receiver, on average). The method may result in easier signal processing and easier differentiation of ones and zeros. This may lead to a MTP reader 102 with a greater read distance and simpler processing.

For example, the MTP 104 may be queried with a light flashing at 1 MHz with a 50% duty cycle. This may be accomplished with a laser or a focused LED, or the like.

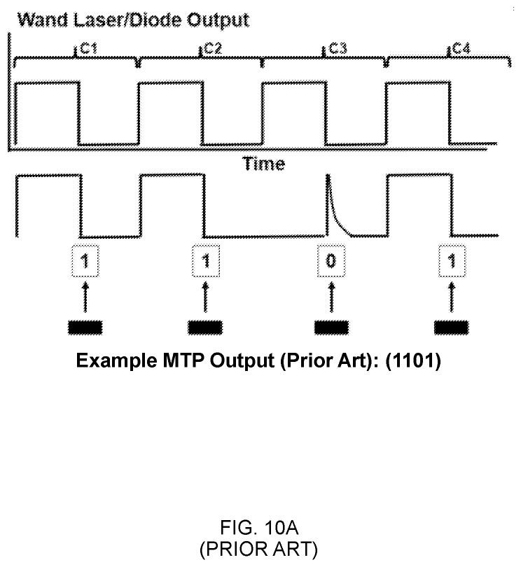

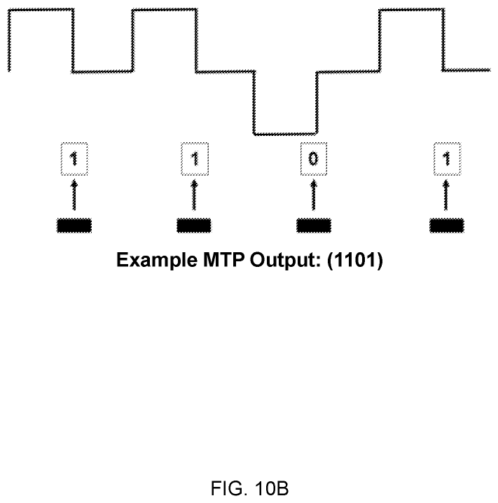

FIG. 10A illustrates in simplified form how a string of “1101” is transmitted under an old system, and FIG. 10B illustrates in simplified form how a string of “1101” is transmitted under a reverse antenna system described herein, respectively. For each off/on cycle, such as c1, c2, c3 or c4 of FIGS. 10A-10B, the MTP reader may seeks 102 a radio signal identifying a “1” digital signal or “0” digital signal transmission. As shown in simplified form, for the first illustrative MTP output of FIG. 10A illustrating a prior art system, zeros are transmitted when the light source is off. However, the photocell capacitance used to transmit the zero is limited. In fact, this limited signal denotes a “0.” The limited energy applicable to zero means that signal-to-noise at the MTP reader 102 is restrained by the signal to noise ratio (SNR) for the zero. This means that while in principle the “1”s can be read at a significantly greater distance, MTP signal may only be read at the shorter distance applicable to the “0” components of the signal. A method is provided herein that includes reversing the direction of the current in the RF output antenna to transmit a “0” digital signal so as to use substantially the same current for the “1” digital signal and the “0” digital signal (see FIG. 10B). In some embodiments different from FIG. 10B, any given bit (“1” or “0”) or digital signal in the p-Chip™ MTP may be transmitted within 8 consecutive light cycles.

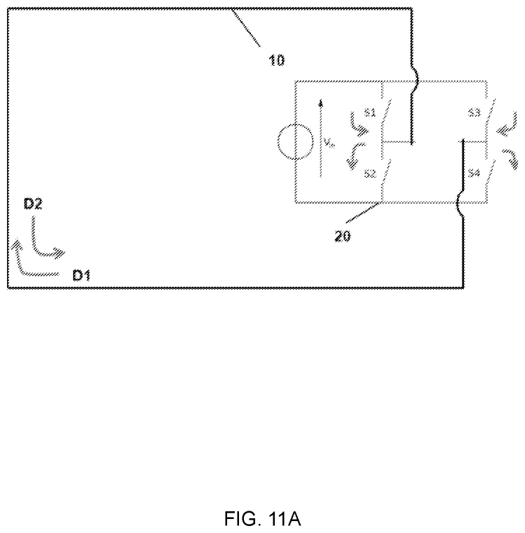

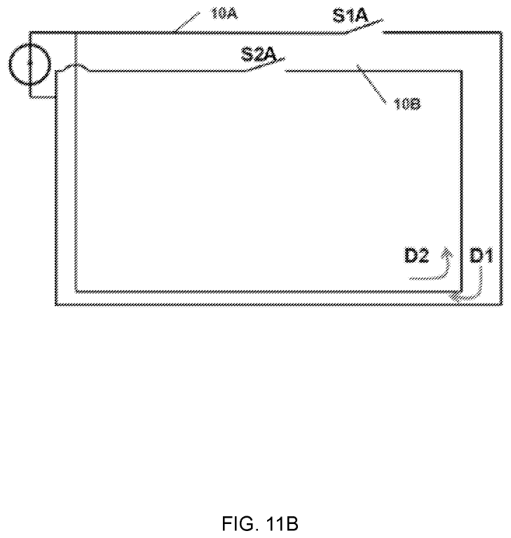

One way of reversing the antenna current is to use a switching circuit such as an H-bridge. FIG. 11A shows one example diagram of reversing the direction of antenna operation in accordance with some embodiments of the present disclosure. As shown in FIG. 11A, an antenna 10 may be operated by a voltage source Vin and an H-bridge 20. Selectively closing switches S1 and S4 may direct a current through the antenna 10 in the direction indicated by the arrows. Selectively closing switches S2 and S3 may direct a current through the antenna 10 in an opposite direction.

FIG. 11B shows another example diagram of reversing the direction of antenna operation in accordance with some embodiments of the present disclosure. Another way of reversing the antenna current is to use two switches, such as S1A and S2A in FIG. 11B, and two antennas (e.g., 10A, 10B). Selectively closing switch S1A may direct a current through the antenna 10A in one direction indicated by the arrow. Selectively closing switch S2A may direct a current through the antenna 10B in an opposite direction. If S1 is selectively closed, current moves in direction D1. If S2A is selectively closed, current moves in direction D2, opposite the direction D1. The antenna may be formed in separate metal layers, or on the same layer. Only one FET (S1A or S2A) may be closed at any given time. When either FET is turned on a reverse current may be coupled into the other antenna. The body diode of the off FET may provide a current path for the coupled signal.

In some embodiments, the antenna options described herein may be effected in a monolithic integrated circuit. In some embodiments, the monolithic integrated circuit may be sized about 2 mm×2 mm×0.2 mm or less in thickness.

In some embodiments, the signal strength for a MTP incorporating the above-described bi-phase transmission is increased by about 6 dB. This will increase the reliable read distance of the MTP reader 102. In some embodiments, the number of cycles committed to transmitting a one bit is 8 data periods. Each laser cycle is one data period. Every time the number of data periods is doubled there is a signal processing gain of 3 dB. Eight data periods is 3 doublings (2,4,8). This results in a signal processing gain of 9 dB. By being increased from 8 to 64 (2, 4, 8, 16, 32, 64) or 128(2 , 4, 8, 16, 32, 64, 128) the signal processing gain may increase from 9 dB to 18 dB (for 64 repeats) or 21 dB (for 128 repeats). An example MTP using a repeat of 8 times for its 64 data cells when using a laser at 1 MHz may transmit IDs at a rate of 2,000 per second. By increasing the repeat rate to 128 the read rate may decrease to 128 reads per second with a signal gain of 21 dB. This may result in an increased read distance. The laser rate may be increased or decreased (e.g., in a range of 500KHz to 5MHz). The repeat rate may be controlled by selecting one of 8 repeat rates (3 addition memory bits).

### Multiple MTP Indexed Security Feature

Some embodiments may use authentication of multiple microtransponders, or combinations of microtransponders and taggants (e.g., QR codes, barcodes, RFID tags, etc.) as matched pairs to establish a higher level of security. All taggants must be present and readable to validate the contents. The taggants may be placed next to one another or at different locations on the surface of the object or within the object, and/or at least two different types of security markings can be combined to form a compounded security marking. Failure of any microtransponder or other taggant to respond may indicate non-authentic contents. At least one microtransponder in the multi-level indexing sequence may be a fragile chip that may be rendered physically unable to respond when the container is initially opened. Fragile chips can be produced by post fabrication processing, i.e., thinning of the chip substrate to ensure it breaks when bent or removal from the substrate is attempted. In some embodiments, a method for ensuring chip incapacitation may be implemented by designing a fracture plane or cutting a slot into the chip to disconnect the antennae.

In one embodiment, a physical object (e.g., a container) may be attached with chip A and chip B from a legitimate pairing when both signals respond to interrogation.

In one embodiment, if a physical object is only attached with chip A and chip B is not physically present for interrogation by the reader, a reader may not authenticate this product as the database needs a response from both chips. If the physical object has both chip A and chip B present, but chip B may be broken on opening, the reader may not authenticate this product as chip B is incapacitated.

In one embodiment, similar to the example of the physical object with chip A and chip B, the physical object may have a different pairwise or legitimate pairing indexing via chip C and chip D. While the pairing of chip C and chip D may be legitimate, it may be unique and not equal to the pairing of chip A and chip B. If counterfeiters acquire chips A and C and add them to their packages. The reader may be unable to authenticate the chips as chip A and chip C do not constitute a legitimate pairing.

### Enhanced Read Distance Microtransponder (MTP)

Some example MTPs may have limited read capability when attached directly to metal substrates. Modulated light required to activate solar cells of a MTP may interact with the metallic substrate which may generate eddy currents in the metal. The generated eddy currents may reduce the RF signal intensity response from the MTP. The ability to successfully acquire and decode the RF signal containing the unique identity number of a MTP is a function of a signal distance between the MTP and its reader.

Embodiments of the present disclosure describe techniques of enhancing read distance for MTPs by eliminating the eddy currents. Signal distance for microtransponders directly attached to metallic surfaces may be reduced by up to 30% compared to non-metallic substrates. The enhanced read distance MTP may be embedded with durable self-destructive PUF functions as described. It may be possible to build a physical gap between metal substrates and objects effected by eddy currents. Such schemes may rely on tapes, shims or filled polymeric adhesives, laminates or films that are external to Integrated Circuit (IC) manufacture and structures. Given the wide range of substrates and attachment methods for end use applications of a P-Chip™ MTP, a single high volume, affordable solution may not be possible for post manufacture isolation of the MTP from the metallic substrate. It may be advantageous to achieve the resistance to eddy currents from metal substrates as part of the on-chip structures.

In some embodiments, successful elimination of eddy currents may be achieved with active or passive materials and or combinations thereof. Active materials may absorb, scatter, destroy or reflect the Eddy currents away from the chip and its signals. Filler materials such as ferrite are also known to act as active materials. Passive materials may not interact at all with the eddy currents and provide a physical separation between the substrate and the IC signals. Glass, ceramics and inorganic media are known materials providing passive separation and are compatible with IC manufacturing.

In some embodiments, the base or near base layer of IC design may be fabricated with a passive material or filled with an active material. A base layer may be formed post foundry by attaching passive or active substrate to the MTP chip.

Various methods or technologies may be utilized for the base layer of IC design, but not limited to the methods or technologies, including:

Physical build processing by vapor phase or chemical deposition. While most passivation layers are built to eliminate corrosion of the IC & components, extending the thickness of the back of the chip by deposition of a non-conducting inorganic layer acts as a physical spacer to isolate the IC and its circuitry from the metal substrate causing interference.

Physical layer build processing from liquid media with subsequent thermal or radiation curing in a field of polysilazane/polysiloxane chemistry. The two chemistries described are capable of making durable non-conducting films and structures with excellent adhesion to other inorganic surfaces. Such sol-gel systems can be applied as a liquid coating by casting, spraying, dip or spin based applications to precise films.

Attachment of active or passive monolithic layer to wafer by liquid, gel or solid media followed by thermal or radiation curing in a field of polysilazane/polysiloxane chemistry. The same sol-gel systems may be used as adhesives to bind other structures such as a glass sheet to the back of an IC wafer. In some embodiments, a passive monolithic layer may be glass or a filled glass structure.

Hybrid organic-inorganic polymeric matrices may be considered as they have greater flexibility and may be an organic route to lower temperature applications. One drawback of sol-gel films is that they may be brittle. Adding small amounts of organic materials into the inorganic sol-gel system may decrease brittleness. A material tradeoff of creating a hybrid sol-gel is that the high temperature resistance is degraded.

End use applications may be directed to metal or contain metal filled layers or particles.

The present disclosure may identify known or perceived conditions of use, range of efficacy or limitations. While high temperature service conditions are key features of a P-Chip™ MTP, metallic objects used in low or ambient temperature applications such as asset tagging are equally important. Therefore, organic-based eddy current elimination schemes may also be utilized for low to ambient temperature applications. During the manufacturing process of MTP with the enhanced signal distance, various material may be used, but not limited to inorganic films, coatings and adhesives, high temperature hybrid organic-inorganic matrices and materials, and high temperature organic insulating materials, etc.

### Battery Taggant Systems and Methods

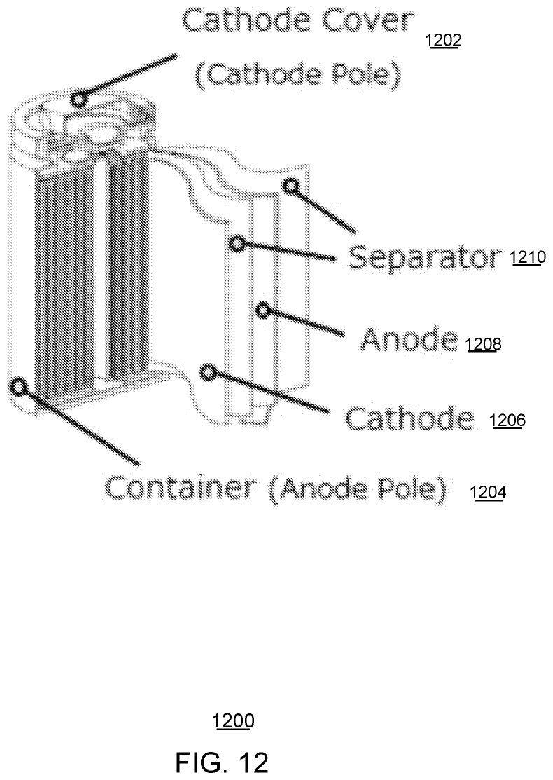

FIG. 12 illustrates an example battery cell 1200, according to example embodiments of this disclosure. As shown, the cell 1200 may include an anode 1208 and a cathode 1206 separated by a separator 1210. For example, the cathode 2106-(“inner”) separator 1210-anode 1208 combination may be formed as long sheets and wrapped around tightly, with another (“outer”) separator 1210 providing an insulation in between, into a cylindrical cell. The “inner” separator 1210 may have electrolytes forming a barrier for electrons but allowing positive ions to pass through, such that the traversal of the electrons between the cathode 1206 and the anode 1208 is through an external circuit. The external circuit may include a load when the cell 1200 is being used and may be a power source when the cell 1200 is being charged. A cathode pole 1202 and an anode pole 1204 may provide connection points to the external circuit.

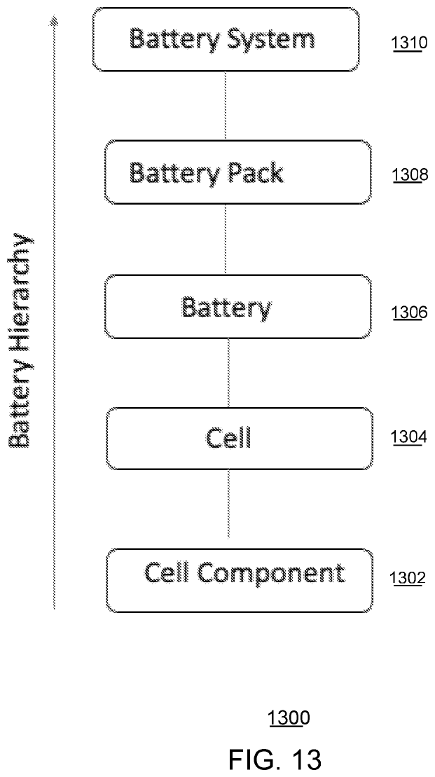

FIG. 13 illustrates an example battery hierarchy 1300, according to example embodiments of this disclosure. As shown, the lowest level of hierarchy may be a cell component 1302 (e.g., cathode 1206, anode 1208, separator 1210, etc., as shown in FIG. 12). The next level of hierarchy may be a cell 1304 (e.g., cell 1200 shown in FIG. 12). A battery 1306 comprising multiple cells may form the next level of hierarchy. Moving up, a battery pack 1308 comprising multiple batteries may from another level of hierarchy. Finally, a battery system 1310 comprising multiple battery packs may form a top level of hierarchy. It should be understood that this is an example hierarchical structure and should not be considered limiting to all possible battery hierarchies.

Optically Activated Microtransponders (MTPs) and All Optical Micro-transponders (OMTPs)—a subclass of MTPs, are described as example security elements throughout this disclosure. As described in U.S. Pat. No. 7,098,394, U.S. Patent Publication No. 2018/0091224, and above, they may be designed to wirelessly transmit a unique incorruptible digital identifier, when scanned with a suitable device (“the reader”). The transmitted signal is in the form of a radio frequency (RF) signal in case of MTPs, and light in the case of OMTPs. These MTPs and OMTPs are described as examples, and other taggants with similar structure and functionality should be considered within the scope of this disclosure. It should further be understood that the term taggant used throughout this disclosure encompasses MTPs/OMTPs and/or any other type of taggant with similar structure and functionality.

The small size of MTPs and OMTPs (e.g., less than 2 cm×2 cm×100 microns) makes it possible to attach them to cell components, cells, batteries, and battery packs without causing significant distortion to the shape or performance of the MTPs/OMTPs or the cell components, cells, batteries, and battery packs. In some embodiments; the MTPs and OMTPs might be less than 500 microns×500 microns×100 microns in size. These sizes are examples and should not be considered limiting to all possible taggants. Further, MTPs can be coupled with sensors to collect useful information about the performance of cells or batteries. Additionally, it should be understood that the functionality of MTPs described in this disclosure is applicable to OMTPs as well.

As discussed above, MTPs can include a silicon chip partially or completely enclosed in an inert casing, such as glass or silicon nitride. This enables the MTP to survive the harsh chemical conditions of battery environments such as strong acids, ionic liquids or corrosive agents Electrolytes used in cells can contain ionic salts in an organic medium. MTPs may be exposed to electrolytes for extended periods (such as multiple months or years). Furthermore, the electrolytes may undergo chemical change, physical change, or both during such periods. Chemical changes could include variation of pH, change in total ionic concentrations, conductivity, formation of oxides, change in chemical composition, etc. Physical changes could include changes in viscosity, color, formation of precipitates, etc. Unlike the conventional RFIDs and NFCs, MTPs are designed to operate in these harsh—and changing—chemical and physical conditions.

MTPs disclosed herein may be attached to cells in a variety of ways. For example, MTPs may be placed on the metal casing of cells on the caps, crimps, gaskets, or coverings. In certain instances, MTPs may be placed beneath the surface of covering to conceal the MTP from visual inspection. Attachment of MTP can be done by physical methods such as heat staking the MTP into a polymeric covering, placing the MTP into interstices of crimps, or by adhesive. Adhesives suitable for this could be either organic, inorganic, one-component or multi-component, and may be able to maintain adhesion during the charge and discharge cycles of battery. Non-limiting examples of one-component adhesives include silicone based, polyurethane based, cyanoacrylate, or methacrylate-based compositions. Non-limiting examples of two-component adhesives include epoxy-based, polyurea-based, polyurethane-based, or reactive acrylate-based compositions. In some embodiments, MTPs may be potted with adhesives, and the potted MTPs may be physically attached to a portion of the battery.

In some embodiments, MTPs disclosed herein may be attached to ancillary parts of the battery system. Such ancillary parts may include, but are not limited to, cables, connectors, pins, adapters, attachments, clips, or cable-ties. For example, certain types of batteries may be connected by cables configured to handle the operational attributes of the battery, such as voltage, operational temperature, chemical resistance, etc. Using cables not configured to handle the operational attributes of the battery may cause problems with battery performance and/or function. MTPs may be used to ensure pairing of battery and correct cables for optimal performance of the battery system. For example, MTPs in cables can be read as described herein, and the information provided through reading the MTPs can verify whether the cables are appropriate for the battery. In another example, the MTPs may be used to authenticate whether ancillary parts are factory-standard ancillary parts provided by the original equipment manufacturer or certified replacement parts. In certain instances, failure to use such authenticated ancillary parts may result in a loss of warranty, making verification through MTP placement and reading a possible safeguard against warranty loss in addition to ensuring performance standards are maintained.

MTPs or OMTPs may also be affixed by a mechanical attachment without the need for an adhesive. For example, an MTP or OMTP may be held in place by an indentation, incision, or protrusion on a surface. In another example, the MTP or OMTP may be molded into, or potted into a cell component. In yet another example, the MTP or OMTP may be heat staked into a substrate. In another example, the MTP or OMTP may be sonic welded and/or ultrasound welded onto a surface. In yet another example, the MTP or OMTP may be heat-shrunk onto a cell component or auxiliary part. Heat shrinking may involve temporarily softening a polymer through the application of heat and applying the MTP to the softened polymer, thereby securely affixing the MTP in place upon cooling. The polymer may be pre-cut to precise dimensions or pre-associated with an MTP in some embodiments.

In one or more embodiments, MTPs may be attached to components within a cell. Components of a cell may include, for example, a separator, current collector, electrodes, safety valves, gaskets, a current interrupt device, positive temperature coefficient (PTC) thermistor, or electrolyte. The electrolyte may be a liquid, solid or a viscous paste-like material. MTPs may be installed on the cell components via physical processes like heat-staking, in-line molding, 3D-printing, or by using an adhesive. Adhesives suitable for this could be either one-component or multi-component and may be able to maintain adhesion during the charge and discharge cycles of battery. Non-limiting examples of one-component adhesives include silicone based, polyurethane based, cyanoacrylate, or methacrylate-based compositions. Non-limiting examples of two-component adhesives include epoxy-based, polyurea-based, polyurethane-based, or reactive acrylate-based compositions.

FIG. 3 shows example components of a cell 302 where an MTP 324 may be attached, according to example embodiments of this disclosure. It should be understood that the attachments to the components are examples and should not be considered limiting for all possible attachment and/or component options. The MTP 324 may be attached to other components of the cell 302 in some embodiments.

As shown, the cell 302 may include tab 304 (e.g., providing a positive connection terminal to an external circuit) and/or tab 306 (e.g., providing a negative connection terminal to the external circuit). As further shown, the cell 302 may be formed of a separator sheet 308, positive active material layer 310, current collector 312 (e.g., formed of aluminum), positive active material layer 314, separator sheet 316 (e.g., which may contain electrolytes), negative active material layer 318, current collector 320 (e.g., formed of copper), and negative active material 322. The tab 304 may be attached to the current collector 312 and the tab 306 may be attached to the current collector 320.

The MTP 324 may be attached to any of these components. For example, the MTP 324 may be attached to the separator sheet 308, the current collector 312, the separator sheet 316, and/or the current collector 320. Because of its relatively small size and resilience to electrochemical activities (at least because of its monolithic structure), the MTP 324 may be attached to any of these components. Such attachment may not affect the normal functionality of the cell 302.

Battery malfunction may occur as result of any or combination of factors such as overheating of battery, faulty manufacturing, variations over multiple charge-discharge cycles or simply end of battery life. Battery malfunction may also result in a thermal event followed by a discharge of materials from the battery. An effective battery taggant may have to be capable of surviving such an event. MTPs may be well suited for tagging battery components as they are insensitive to electrical shock and continue to function unaffected in case of the battery malfunction or charge dissipation.

Furthermore, because of the relatively small size of the MTPs, these can be used to create a hierarchical authentication scheme. To take an example of a battery pack having a plurality of batteries, each of which has a plurality of cells, different MTPs can be organized at different levels of hierarchy. An MTP for the battery pack may form a first level of hierarchy, MTPs for individual batteries may form a second level of hierarchy, and MTPs for individual cells may form a third level of hierarchy. It should be understood that these hierarchies are merely examples and additional hierarchies should also be considered within the scope of this disclosure. For instance, this example can easily be expanded to have additional hierarchies with MTPs attached to cell components and/or an MTP attached to a battery system that includes the battery pack.

Continuing with this example battery pack, different hierarchical combinations of MTPs can be used for authentication. For example, the MTP for the battery pack can be used to authenticate all of the battery pack, its constituent batteries, and their constituent cells. Alternatively, a combination of the MTPs for the batteries may be used to authenticate the batteries and the battery pack, for example by comparing the combination with a stored combination. Or, a hierarchical combination of MTPs of cells and the MTP for a corresponding battery can be used to authenticate the battery. Or, at the third level of hierarchy, corresponding MTPs can be used to individually authenticate corresponding cells. In some embodiments, a predetermined subset of the hierarchical MTPs can be used in combination to authenticate the entire hierarchy. For example, in a battery pack with ten levels of hierarchy, authenticating the first, third, and eighth levels (or any other multi-level combination) may suffice to authenticate the entire battery pack.

Therefore, any individual MTP or a combination of MTPs—combination within the same level of hierarchy or different levels of hierarchy—can be used for authentication. Such combinations may allow for a stronger authentication. For example, it may be significantly harder to mimic or replace a combination of MTPs that to mimic or replace one MTP, if at all possible. Additionally, the combination may provide redundancy. For example, in the scenario where one or more MTPs are destroyed or damaged, other MTPs may be used to ascertain the authenticity of a corresponding battery, cell, etc.

The hierarchical arrangement of the MTPs may further aid recycling or repurposing of the batteries. For example, a subset of cells within a first battery, with cell level MTPs associated to a battery level MTP, may be combined with a subset of cells within a second battery, also with cell level MTPs and a battery level MTP, to form a third repurposed battery with its own battery level MTP and cell level MTPs. For this third repurposed battery, MTPs from the corresponding subset of cells may be associated with the battery level MTP. Therefore, the hierarchy allows for flexibility of combinations, in addition to stronger authentication with built-in redundancy.

At times, it might be useful to ascertain the origin of all the materials used in the manufacture of the batteries. Non-limiting examples of this could be to ascertain and certify that the minerals were obtained in fair-manner, free of conflict minerals or free of child labor. Using MTPs or OMTPs can enable such authentication and certification.

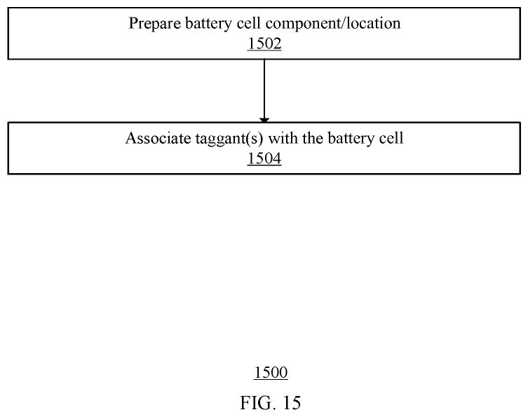

FIG. 15 shows a flow diagram of an example method 1500 of tagging a battery cell or component thereof, according to example embodiments of this disclosure. It should be understood that the steps of the method 1500 are merely examples and should not be considered limiting. Methods with additional, alternative, or fewer number of steps should be considered within the scope of this disclosure.

At step 1502, a battery cell or component may be prepared. As described throughout this disclosure, the battery cell may include various elements and/or structures. The preparation of the battery cell should be understood to include any type of processing needed to enable fixing of the taggant(s) to the intended component and/or location, such as applying adhesive or making any mechanical adjustments necessary to accept the taggant(s).

At step 1504, taggant(s) may be associated with the battery cell. A taggant may include, for example, a light triggered microtransponder comprising a monolithic integrated circuit, wherein the monolithic integrated circuit is enclosed within a passivation layer that forms a barrier with the edible matrix. In some embodiments, the monolithic circuit may have maximum dimensions of 2 mm length, 2 mm width, and 0.2 mm thickness.

As used herein, an association of the taggant with the battery cell (or any other component) should be understood to include any one of a physical attachment, embedding, co-location, side-by-side placement, placement in proximity, placement within a same box or container, a digital association, and/or the like. Similarly, an association of an MTP with the battery cell (or any other component) should be understood to include any one of a physical attachment, embedding, co-location, side-by-side placement, placement in proximity, placement within a same box or container, a digital association, and/or the like. Therefore, an association should be understood as a broader embodiment of a physical or non-physical functional combination of two components.

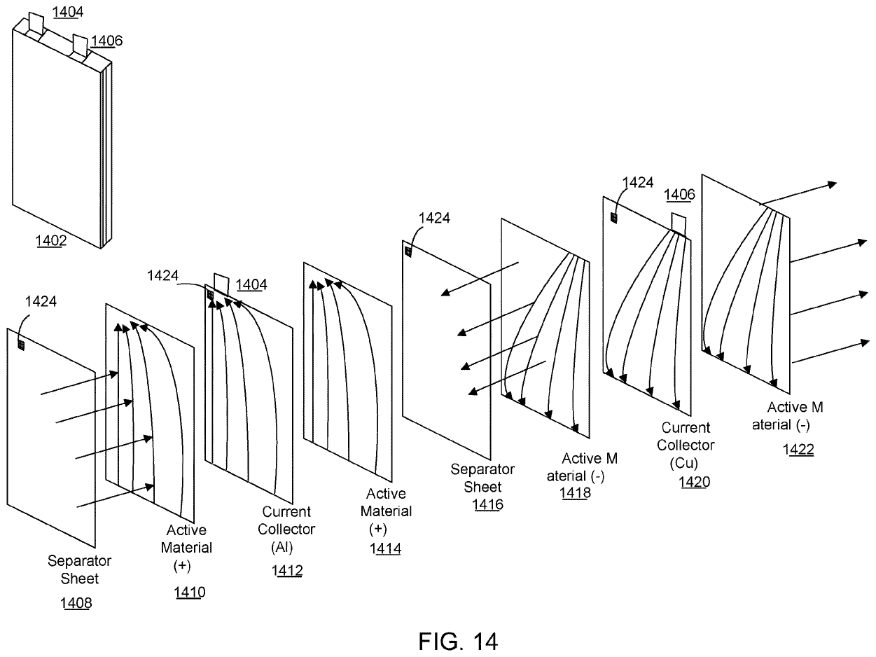

In some embodiments, a plurality of taggants may be associated with the battery cell. Each of the taggants may include a light triggered microtransponder comprising a monolithic integrated circuit, wherein the monolithic integrated circuit is enclosed within a passivation layer that forms a barrier with the edible matrix. The plurality of taggants may form a taggant system (for example, as described in reference to FIG. 14), wherein any combination of the taggants may be used to determine the provenance of the battery cell, including in a hierarchical fashion in some embodiments.

Once associated with the battery cell, taggant(s) may be scanned as described herein. Each scan can include information such as the identity of the scanned item, time of the scan, location of the scan, identity of the equipment and processing parameters and/or person performing the scan, the position of the scanned item relative to other objects scanned and information about the packaging holding the object, all of which may form a data packet. A chronological record of multiple such scans and resulting data packets can be created and stored on a computer-readable medium, and additionally be accessed and verified as necessary by authorized users. Further, such a record may be prevented from being edited, thereby avoiding any possibility for falsification. In some embodiments, at least a portion of the record may be stored on the MTP itself. In some embodiments, the record may be securely stored in a blockchain or other secure storage media.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted as a means plus function limitation (e.g., under 35 U.S.C. 112(f) in the United States). Claims that do not expressly include the phrase “means for” or “step for” are not to be interpreted as means plus function limitations (e.g., under 35 U.S.C. 112(f)).

1-64. (canceled)

65. A taggant for a battery cell, the taggant comprising:
a microtransponder attached to at least one of:
a component of a battery cell,
a location on the battery cell,
a location in the battery cell,
a location on an ancillary part of the battery cell, and
a location in the ancillary part of the battery cell,
the microtransponder configured to provide digital information to a reader, thereby enabling the reader to authenticate the battery cell.

66. The taggant of claim 65, wherein the component comprises at least one of a separator, a current collector, an electrode, a safety valve, a gasket, a current interrupt device, a covering, a positive temperature coefficient (PTC) thermistor, and an electrolyte.

67. The taggant of claim 65, wherein the microtransponder comprises at least one of:
an integrated circuit having maximum dimensions of 2 mm length, 2 mm width, and 0.2 mm thickness; and
a light-triggered microtransponder.

68. The taggant of claim 65, wherein the location comprises at least one of a cap, a crimp, a gasket, a covering, a position beneath a visible surface of the battery cell, and a position overtly or covertly on and/or in a visible surface of the battery cell.

69. The taggant of claim 65, wherein the microtransponder is attached to the battery cell by at least one of: heat staking the microtransponder into a polymeric covering of the battery cell, placing the taggant into interstices of a crimp, fabricating the microtransponder into a cell casing or cover of the battery, and using an adhesive and/or a label.

70. The taggant of claim 69, wherein the adhesive comprises at least one of a one-component adhesive, a two-component adhesive, and a UV cured and/or pressure sensitive adhesive.

71. The taggant of claim 70, wherein the one-component adhesive comprises at least one of a silicone-based composition, a polyurethane-based composition, cyanoacrylate-based composition, and a methacrylate-based composition.

72. The taggant of claim 70, wherein the two-component adhesive comprises at least one of an epoxy-based composition, a polyurea-based composition, polyurethane-based composition, and a reactive acrylate-based composition.

73. A battery taggant system in a battery environment, the battery taggant system comprising:
at least one first unit comprising the taggant of claim 65, the at least one first unit forming at least a first level of hierarchy in the battery taggant system; and
at least one second unit comprising the taggant of claim 65, the at least one second unit forming at least a second level of hierarchy in the battery taggant system;
wherein the digital information provided to the reader enables the reader to individually or hierarchically authenticate a corresponding portion of the battery environment.

74. The battery taggant system of claim 73, wherein:
the battery environment comprises at least one of a single battery cell, a battery, a battery pack, a battery system, and at least one ancillary part of the battery system;
the at least one first unit is attached to one of the battery cell, the battery, the battery pack, the battery system, and the at least one ancillary part of the battery system; and
the at least one second unit is attached to one of a cell component within the battery cell, the battery cell within the battery, the battery within the battery pack, the battery pack within the battery system, and the at least one ancillary part of the battery system.

75. The battery taggant system of claim 74, wherein the at least one ancillary part of the battery system comprises at least one of a cable, a connector, a pin, an adapter, an attachment, a clip, and a cable-tie.

76. The battery taggant system of claim 73, wherein the individual authentication comprises a corresponding unit authenticating the corresponding portion without combining with other units.

77. The battery taggant system of claim 73, wherein the hierarchical authentication comprises at least one of:
a corresponding unit authenticating the corresponding portion in combination with at least another unit at a different level of hierarchy; and
a corresponding unit authenticating the corresponding portion in combination with at least another unit at a same level of hierarchy.

78. A method comprising:
attaching a microtransponder to at least one of:
a component of a battery cell;
a location on the battery cell,
a location in the battery cell,
a location on an ancillary part of the battery cell, and
a location in the ancillary part of the battery cell,
wherein the microtransponder is configured to provide digital information to a reader, thereby enabling the reader to authenticate the battery cell.

79. The method of claim 78, wherein the location comprises at least one of a cap, a crimp, a gasket, a covering, a position beneath a visible surface of the battery cell, and a position overtly or covertly on and/or in a visible surface of the battery cell.

80. The method of claim 79, wherein attaching the microtransponder comprises at least one of heat staking the microtransponder into a polymeric covering of the battery cell, attaching the microtransponder to the location by a process including heat shrinking the location, placing the taggant into interstices of a crimp, fabricating the microtransponder into a cell casing or cover of the battery, and using an adhesive and/or a label.

81. The method of claim 80, wherein the adhesive comprises at least one of a one-component adhesive, a two-component adhesive, and a UV cured and/or pressure sensitive adhesive.

82. The method of claim 81, wherein the one-component adhesive comprises at least one of a silicone-based composition, a polyurethane-based composition, cyanoacrylate-based composition, and a methacrylate-based composition.

83. The method of claim 81, wherein the two-component adhesive comprises at least one of an epoxy-based composition, a polyurea-based composition, polyurethane-based composition, and a reactive acrylate-based composition.

84. The method of claim 78, wherein the microtransponder comprises at least one of:
an integrated circuit having maximum dimensions of 2 mm length, 2 mm width, and 0.2 mm thickness; and
a light-triggered microtransponder.

85. The method of claim 78, wherein the microtransponder comprises at least one first microtransponder, the location comprises at least one first battery component, and the at least one first microtransponder forms at least a first level of hierarchy in a battery taggant system, the method further comprising:
attaching at least one second microtransponder to at least one second battery component, the at least one second microtransponder forming at least a second level of hierarchy in the battery taggant system;
wherein each of the first microtransponder and the second microtransponder is configured to provide digital information to a reader, thereby enabling the reader to individually or hierarchically authenticate a corresponding portion of the battery environment.

86. The method of claim 85, wherein:
the battery environment comprises at least one of a single battery cell, a battery, a battery pack, a battery system, and at least one ancillary part of the battery system;
the at least one first microtransponder is attached to one of the battery cell, the battery, the battery pack, the battery system, and the at least one ancillary part of the battery system; and
the at least one second microtransponder is attached to one of a cell component within the battery cell, the battery cell within the battery, the battery within the battery pack, the battery pack within the battery system, and the at least one ancillary part of the battery system.

87. The method of claim 86, wherein the at least one ancillary part of the battery system comprises at least one of a cable, a connector, a pin, an adapter, an attachment, a clip, and a cable-tie.

88. The method of claim 85, wherein the individual authentication comprises a corresponding microtransponder authenticating the corresponding portion without combining with other microtransponders.

89. The method of claim 85, wherein the hierarchical authentication comprises at least one of:
a corresponding microtransponder authenticating the corresponding portion in combination with at least another microtransponder at a different level of hierarchy; and
a corresponding microtransponder authenticating the corresponding portion in combination with at least another microtransponder at a same level of hierarchy.

90. A method comprising:
reading, with a reader, digital information provided by at least one microtransponder attached to at least one of:
a component of a battery cell,
a location on the battery cell,
a location in the battery cell,
a location on an ancillary part of the battery cell, and
a location in the ancillary part of the battery cell; and
authenticating, by the reader, the battery cell using the digital information.

91. The method of claim 90, wherein:
the at least one microtransponder comprises a light-triggered microtransponder; and
the reading comprises activating the light-triggered microtransponder by emitting a light and receiving the digital information in response to the activating.

92. The method of claim 90, wherein the microtransponder comprises at least one of:
an integrated circuit having maximum dimensions of 2 mm length, 2 mm width, and 0.2 mm thickness; and
a light-triggered microtransponder.

93. The method of claim 90, wherein:
the at least one microtransponder comprises at least one first microtransponder and at least one second microtransponder;
the at least one first microtransponder is attached to at least one first battery component, the at least one first microtransponder forming at least a first level of hierarchy in a battery taggant system;
the at least one second microtransponder is attached to at least one second battery component, the at least one second microtransponder forming at least a second level of hierarchy in the battery taggant system; and
each of the first microtransponder and the second microtransponder is configured to provide digital information to the reader, thereby enabling the reader to individually or hierarchically authenticate a corresponding portion of the battery environment.

94. The method of claim 93, wherein the authenticating comprises at least one of:
a corresponding microtransponder authenticating the corresponding portion without combining with other microtransponders;
a corresponding microtransponder authenticating the corresponding portion in combination with at least another microtransponder at a different level of hierarchy;
a corresponding microtransponder authenticating the corresponding portion in combination with at least another microtransponder at a same level of hierarchy.

95. The method of claim 93, wherein at least one of the at least one first microtransponder and the at least one second microtransponder comprises at least one of:
an integrated circuit having maximum dimensions of 2 mm length, 2 mm width, and 0.2 mm thickness; and
a light-triggered microtransponder.
